(19) United States
(12) Patent Application Publication
(10) Pub. No.: US 2015/0249656 A1
(43) Pub. Date: Sep. 3, 2015

(54) NETWORK CONNECTION SHARING METHOD AND NETWORK CONNECTION SHARING SYSTEM

(71) Applicant: Primax Electronics Ltd., Neihu (TW)

(72) Inventor: HUA-ZHONG WU, Neihu (TW)

(21) Appl. No.: 14/318,123

(22) Filed: Jun. 27, 2014

(30) Foreign Application Priority Data
Feb. 28, 2014 (CN) 201410072515.2

(51) Int. Cl. H04L 29/06; H04L 12/18; H04W 12/08

(52) U.S. Cl. CPC H04L 63/083; H04W 12/08; H04L 12/18

(57) ABSTRACT

A network connection sharing method is provided. A first electronic device is set as a hotspot by a first application program module of the first electronic device, so that a wireless network is shared by the first electronic device. After a service set identifier and a password of the wireless network are converted into a two-dimensional code image by the first application program module, the two-dimensional code image is outputted from an image output device of the first electronic device. After the two-dimensional code image is read by an image input device of a second electronic device and analyzed by a second application program module of the second electronic device, the service set identifier and the password are acquired. The second electronic device is connected to the wireless network according to the service set identifier and the password.

### FIELD OF THE INVENTION

The present invention relates to a network connection sharing method and a network connection sharing system for an office machine with a network connecting and sharing function, and more particularly to a network connection sharing method and a network connection sharing system using a two-dimensional code image to transmit information.

### BACKGROUND OF THE INVENTION

Generally, for allowing an office machine to be connected to a wireless network, the user has to operate an operation panel of the office machine to select a service set identifier (SSID) of the wireless network to be connected. According to the practical requirements, the office machine is connected to the wireless network when a correct password is inputted.

However, since the operation panel of the office machine is usually very small, it is difficult to virtually check the operation panel. In addition, due to the small area of the operation panel, the possibility of erroneously touching the operation panel or erroneously inputting data is increased. Moreover, if the operation panel of the office machine is not a touch-type operation panel, the user has to press the corresponding buttons to select the correct items in order to input the corresponding data. Under this circumstance, the use of the office machine is troublesome.

Moreover, for connecting a mobile device to the wireless network that is shared by the office machine, the user of the mobile device has to operate the operation panel of the office machine to acquire the service set identifier and the password. In other words, the process of connecting the mobile device to the wireless network is also troublesome to the user.

For solving the above drawbacks, the present invention provides an office machine with a network connection sharing function without the need of inputting the password through the operation panel and virtually checking the SSID and the password on the operation panel.

### SUMMARY OF THE INVENTION

The present invention provides a network connection sharing method and a network connection sharing system that can be easily operated.

The present invention provides an easily-operated office machine with a network connection sharing function.

In accordance with an aspect of the present invention, there is provided a network connection sharing method for a first electronic device and a second electronic device. The first electronic device is connected to a mobile communication network or a wired communication network. The network connection sharing method includes the following steps. Firstly, the first electronic device is set as a hotspot by a first application program module of the first electronic device, so that a wireless network is shared by the first electronic device. Then, a service set identifier and a password of the wireless network are converted into a two-dimensional code image by the first application program module, and the two-dimensional code image is outputted from an image output device of the first electronic device. Then, the two-dimensional code image is read by an image input device of the second electronic device, and the two-dimensional code image is analyzed by a second application program module of the second electronic device, so that the service set identifier and the password are acquired and the second electronic device is connected to the wireless network according to the service set identifier and the password.

In accordance with another aspect of the present invention, there is provided a network connection sharing system for a first electronic device and a second electronic device. The first electronic device is connected to a mobile communication network or a wired communication network. The first electronic device includes a first application program module and an image output device. After the first electronic device is set as a hotspot by the first application program module, a wireless network is shared by the first electronic device. A service set identifier and a password of the wireless network are converted into a two-dimensional code image by the first application program module. The two-dimensional code image is outputted from the image output device. The second electronic device includes an image input device and a second application program module. The image input device reads the two-dimensional code image. After the two-dimensional code image is analyzed by the second application program module, the service set identifier and the password are acquired, and the second electronic device is connected to the wireless network according to the service set identifier and the password.

In accordance with a further aspect of the present invention, there is provided an office machine with a network connection sharing function. The office machine includes a wireless network module, a scanning module, an application program, an operation panel, and a printing module. The wireless network module provides the network connection sharing function of the office machine. After a first two-dimensional code image is read by the scanning module, the first two-dimensional code image is transmitted from the scanning module to the application program module. The application program module is connected to the wireless network module and the scanning module. The application program module converts the first two-dimensional code image into a first service set identifier of a first wireless network so as to connect the office machine to the first wireless network. Alternatively, the application program module sets the office machine as a hotspot and converts a second service set identifier of a second wireless network shared by the office machine into a second two-dimensional code image. The operation panel is connected to application program module, and displays the second two-dimensional code image. The printing module is connected with the application program module, and outputs the second two-dimensional code image on a paper.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic functional block diagram illustrating a network connection sharing system according to a first embodiment of the present invention;

FIG. 2 is a flowchart illustrating a network connection sharing method according to a first embodiment of the present invention;

FIG. 3 schematically illustrates a user interface used in the network connection sharing method and the network connection sharing system according to the first embodiment of the present invention;

FIG. 4 schematically illustrates a two-dimensional code image used in the network connection sharing method and the network connection sharing system according to the first embodiment of the present invention;

FIG. 5 schematically illustrates the operating status of the network connection sharing method and the network connection sharing system according to the first embodiment of the present invention;

FIG. 6 is a schematic functional block diagram illustrating a network connection sharing system according to a second embodiment of the present invention; and

FIG. 7 schematically illustrates the operating status of the network connection sharing method and the network connection sharing system according to the second embodiment of the present invention.

### DETAILED DESCRIPTION OF THE PREFERRED EMBODIMENT

As previously described in the conventional technology, it is necessary to select the service set identifier (SSID) of the wireless network and input the password through the operation panel of the office machine. The present invention provides a network connection sharing method and a network connection sharing system without the need of selecting the service set identifier (SSID) of the wireless network and inputting the password through the operation panel of the office machine. Moreover, for connecting a mobile device to the wireless network that is shared by the office machine, it is not necessary for the user of the mobile device to operate the operation panel of the office machine to acquire the service set identifier and the password. By transmitting and receiving a two-dimensional code image, the network connection sharing method and the network connection sharing system of the present invention may be automatically implemented.

The two-dimensional code is also referred as a two-dimensional barcode or a two-dimensional bar code. The two-dimensional code is an image consisting of black and white cells with special geometry in a planer arrangement (i.e. along a two-dimensional direction). The two-dimensional code may record a picture information, a sound information, a character information, a signature information, a fingerprint information or any other digitalized information. In code compilation, the two-dimensional code utilizes the 0 and 1 bit stream concepts which construct an internal logic base of a computer, and uses plural geometric patterns corresponding to the binary system to express character value information. Moreover, the information of the two-dimensional code may be automatically read and processed by using an image input device (e.g. a camera lens module or a scanning module) and the corresponding application program module.

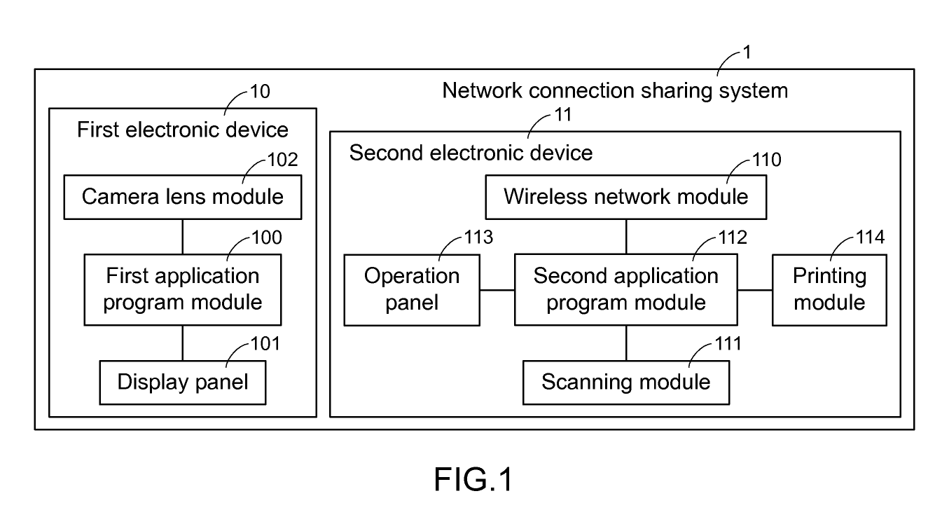

A network connection sharing method and a network connection sharing system according to a first embodiment of the present invention will be illustrated as follows. FIG. 1 is a schematic functional block diagram illustrating a network connection sharing system according to a first embodiment of the present invention. As shown in FIG. 1, the network connection sharing system 1 comprises a first electronic device 10 and a second electronic device 11.

The first electronic device 10 comprises a first application program module 100, a display panel 101, and a camera lens module 102. In this embodiment, the first electronic device 10 is a mobile device. An example of the mobile device includes but is not limited to a mobile phone or a tablet computer. The first application program module 100 may be built in the first electronic device 10. Alternatively, the first application program module 100 may be downloaded from another electronic device and installed in the first electronic device 10 by the user. In this embodiment, the display panel 101 is an image output device for outputting a two-dimensional code image.

In this embodiment, the second electronic device 11 is an office machine with a network connection sharing function. The second electronic device 11 comprises a wireless network module 110, a scanning module 111, a second application program module 112, an operation panel 113, and a printing module 114. The second application program module 112 is connected to the wireless network module 110 and the scanning module 111. Moreover, the operation panel 113 and the printing module 114 are connected to the second application program module 112. In this embodiment, the scanning module 111 is an image input device for reading the two-dimensional code image.

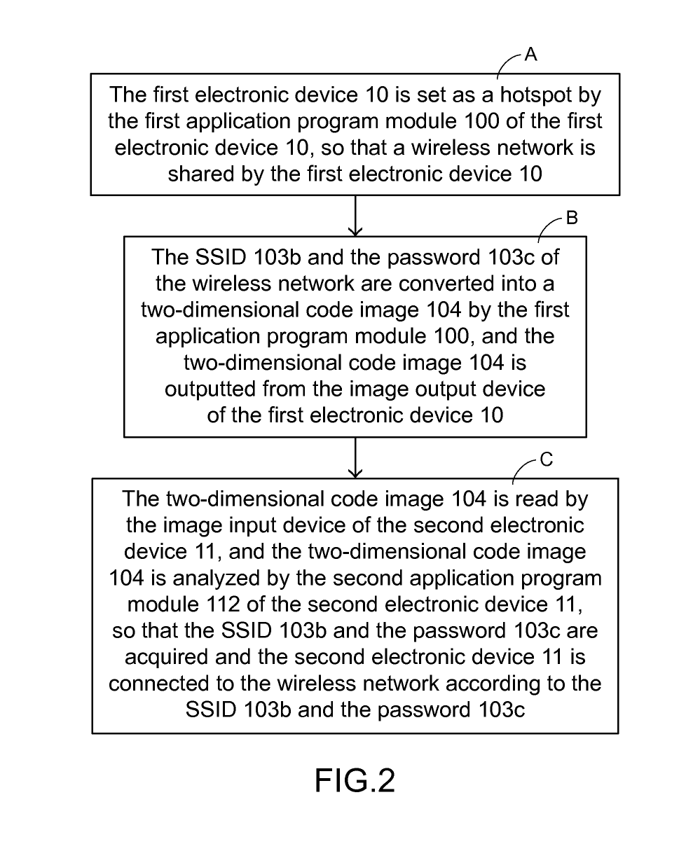

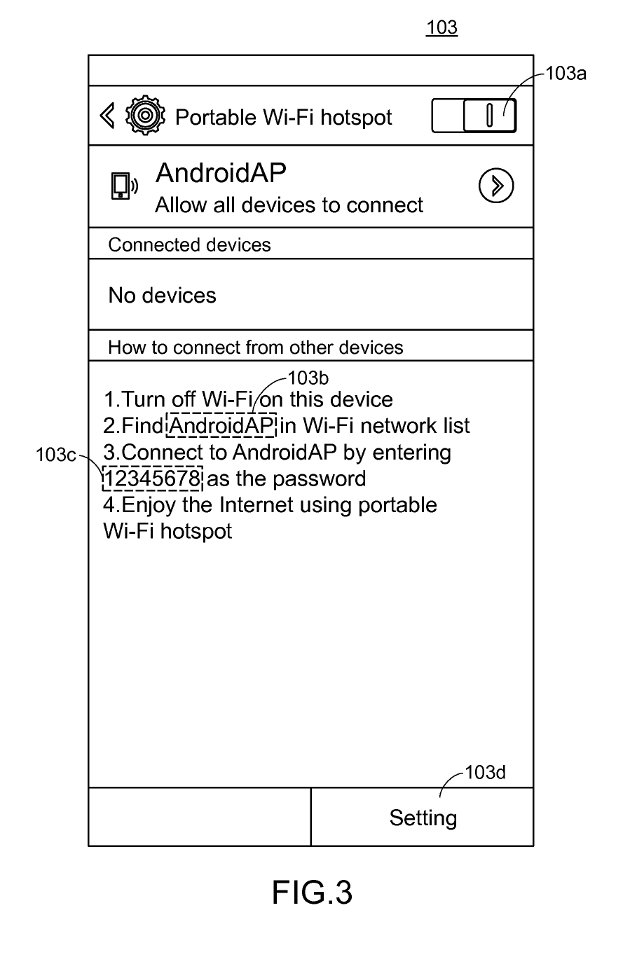

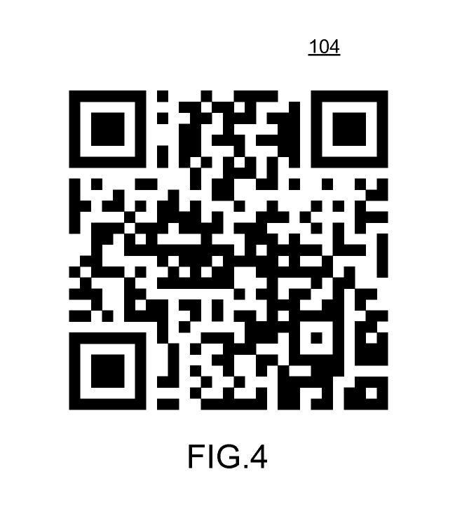

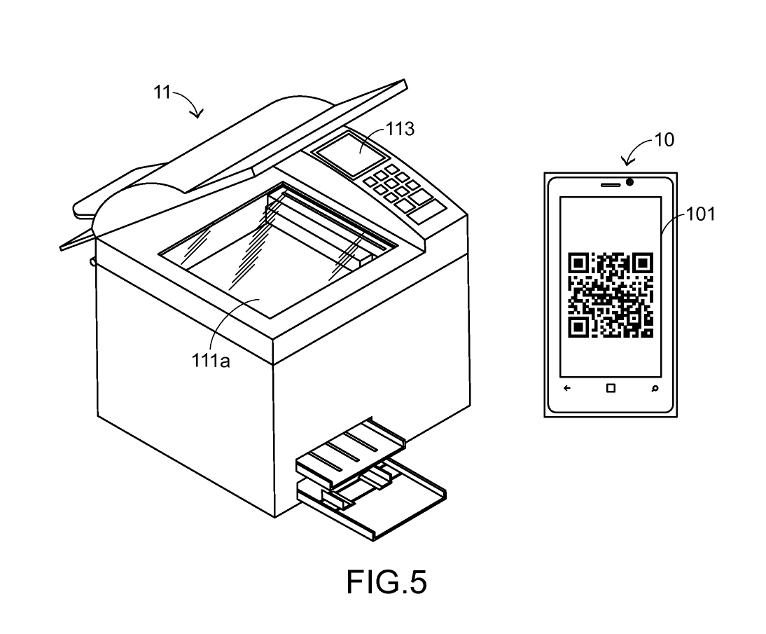

Hereinafter, the operations of the network connection sharing method and the network connection sharing system will be illustrated with reference to FIGS. 1-5. FIG. 2 is a flowchart illustrating a network connection sharing method according to a first embodiment of the present invention. FIG. 3 schematically illustrates a user interface used in the network connection sharing method and the network connection sharing system according to the first embodiment of the present invention. FIG. 4 schematically illustrates a two-dimensional code image used in the network connection sharing method and the network connection sharing system according to the first embodiment of the present invention. FIG. 5 schematically illustrates the operating status of the network connection sharing method and the network connection sharing system according to the first embodiment of the present invention.

Before the network connection sharing method is performed, the first electronic device 10 has been connected to a 2G (second generation of mobile telecommunications technology) mobile communication network, a 3G (third generation of mobile telecommunications technology) mobile communication network, a 4G (fourth generation of mobile telecommunications technology) mobile communication network or a wired communication network. In case that the user wants to share the network connection through the first electronic device 10, the step A is performed at first. In the step A, the first application program module 100 is opened, and the user interface 103 as shown in FIG. 3 is displayed on the display panel 101. Then, by switching a button 103a to an ON position, the first electronic device 10 is set as a hotspot. Then, the hotspot of the first electronic device 10 is configured to establish a wireless network by setting a SSID 103b as “AndroidAP” and setting a password 103c as “12345678”. After the wireless network is established, the wireless network is broadcasted. It is noted that the contents of the user interface 103 as shown in FIG. 3 are presented herein for purpose of illustration and description only.

Moreover, by tapping a setting item 103d, the user may set the SSID 103b and the password 103c of the wireless network by herself (or himself) or further set the wireless network as an open wireless network that can be connected without password.

After the wireless network is successfully established, the step B is performed. In the step B, the first application program module 100 converts the SSID 103b and the password 103c into the two-dimensional code image 104 as shown in FIG. 4 and transmit the two-dimensional code image 104 to the display panel 101. Consequently, the two-dimensional code image 104 is displayed on the display panel 101. It is noted that the contents of the two-dimensional code image 104 as shown in FIG. 4 are presented herein for purpose of illustration and description only. For example, the two-dimensional code image 104 may be an arbitrary image composed of squares, dots or other geometric patterns. The two-dimensional code image 104 is not limited to a QR code image. The two-dimensional code image 104 may be any other appropriate two-dimensional code image that is developed by other institution. In some other embodiments, the two-dimensional code image 104 is a PDF417 code image or a Chinese-sensible code image.

Then, as shown in FIG. 5, the first electronic device 10 is placed on a scanning platform 111a of the scanning module 111 of the second electronic device 11, wherein the display panel 101 faces the scanning platform 111a of the scanning module 111. In this embodiment, the scanning platform 111a is made of glass. It is noted that the structures of the office machine as shown in FIG. 5 are presented herein for purpose of illustration and description only.

The scanning module 111 further comprises a photosensitive element (not shown) and a light source (not shown), which are disposed under the scanning platform 111a. After the scanning module 111 is enabled, a light beam emitted by the light source is projected on the scanning platform 111a and the photosensitive element and the light source are moved by a motor (not shown). As the light beam is projected on and reflected by the two-dimensional code image 104, the two-dimensional code image 104 is successively sensed by the photosensitive element. Consequently, the entire of the two-dimensional code image 104 is acquired. Then, the two-dimensional code image 104 is received and analyzed by the second application program module 112. Consequently, the SSID 103b and the password 103c are realized by the second application program module 112. Afterwards, the wireless network module 110 is accurately connected to the wireless network that is shared by the first electronic device 10 according to the SSID 103b and the password 103c. Meanwhile, the step C is performed.

The encoding and decoding rules of the QR code, the PDF417 code and the Chinese-sensible code are defined by the developer institutions, and the detailed descriptions thereof are omitted herein.

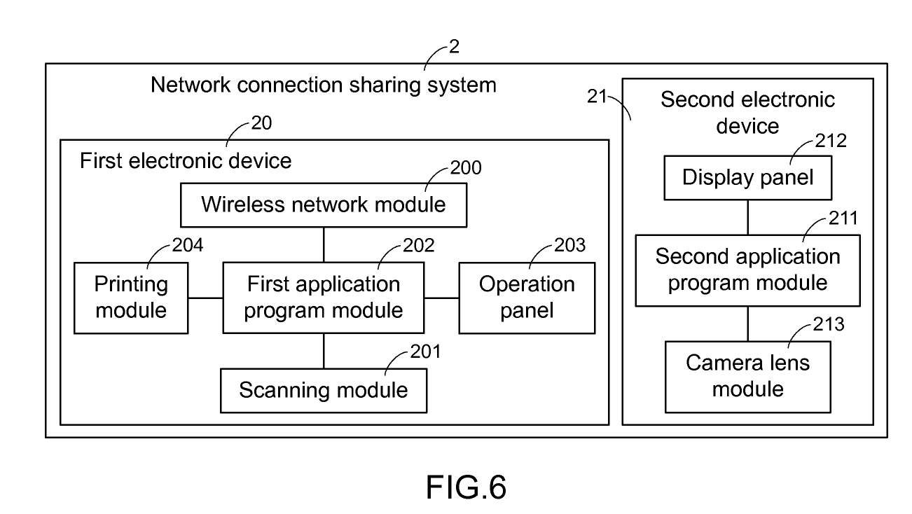

A network connection sharing method and a network connection sharing system according to a second embodiment of the present invention will be illustrated as follows. FIG. 6 is a schematic functional block diagram illustrating a network connection sharing system according to a second embodiment of the present invention. As shown in FIG. 6, the network connection sharing system 2 comprises a first electronic device 20 and a second electronic device 21. In this embodiment, the first electronic device 20 is an office machine with a network connection sharing function. The first electronic device 20 comprises a wireless network module 200, a scanning module 201, a first application program module 202, an operation panel 203, and a printing module 204. The first application program module 202 is connected to the wireless network module 200 and the scanning module 201. Moreover, the operation panel 203 and the printing module 204 are connected to the first application program module 202. In this embodiment, the operation panel 203 and the printing module 204 are image output devices for outputting a two-dimensional code image.

Moreover, the second electronic device 21 comprises a second application program module 211, a display panel 212, and a camera lens module 213. In this embodiment, the second electronic device 21 is a mobile device. In this embodiment, the camera lens module 213 is an image input device for reading the two-dimensional code image.

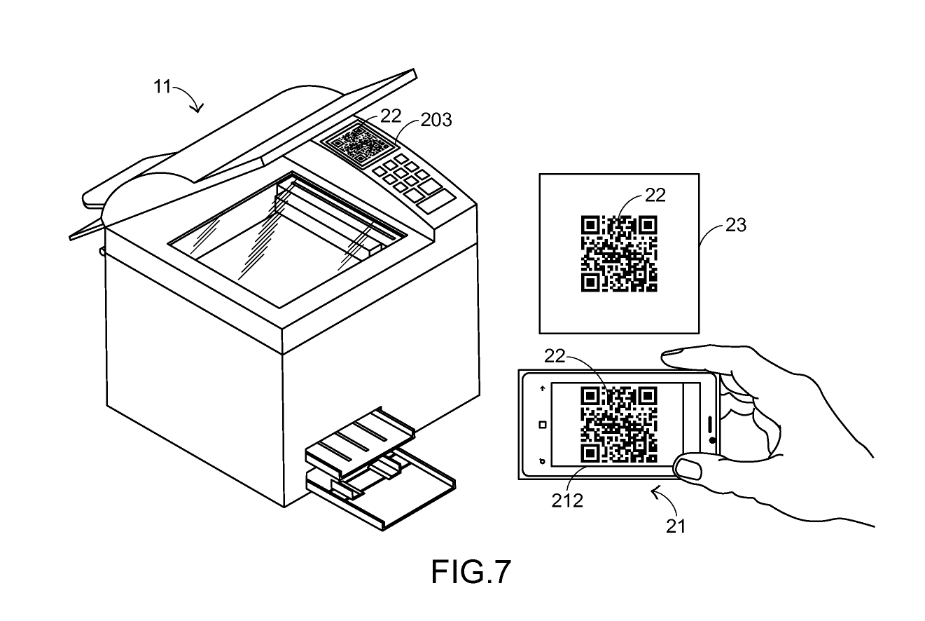

Hereinafter, the operations of the network connection sharing method and the network connection sharing system will be illustrated with reference to FIGS. 2, 6 and 7. FIG. 7 schematically illustrates the operating status of the network connection sharing method and the network connection sharing system according to the second embodiment of the present invention. In comparison with the first embodiment, the first electronic device 20 of this embodiment is an office machine, and the second electronic device 21 of this embodiment is a mobile device. Consequently, in the step A of this embodiment, the user interface is displayed on the operation panel 203. Moreover, in the step B of this embodiment, the two-dimensional code image 22 may be displayed on the operation panel 203, or the two-dimensional code image 22 may be outputted and printed on a paper 23.

In the step C of this embodiment, the second application program module 211 of the second electronic device 21 has to be previously opened, so that the camera lens module 213 is enabled by the second application program module 211. Under this circumstance, the captured image of the two-dimensional code image 22 is displayed on the display panel 212 (see FIG. 7).

Next, the user may aim the camera lens module 213 at the display panel 203 or the two-dimensional code image 22 on the paper 23 while allowing the captured image of the two-dimensional code image 22 to be steadily displayed on the display panel 212. After the two-dimensional code image 22 is successfully read by the camera lens module 213, the two-dimensional code image 22 is transmitted to the second application program module 211. After the two-dimensional code image 22 is analyzed by the second application program module 211, the SSID and the password are realized by the second application program module 211. Afterwards, the second electronic device 21 is accurately connected to the wireless network that is shared by the first electronic device 20 according to the SSID and the password.

From the above descriptions, the present invention provides a network connection sharing method and a network connection sharing system. After a two-dimensional code image generated by a mobile device is read by a scanning module of an office machine, the office machine is connected to a wireless network that is shared by the mobile device. Moreover, after a two-dimensional code image generated by the office machine is outputted from an operation panel or a printing module of the office machine and the two-dimensional code image is read by a camera lens module of the mobile device, the mobile device is connected to a wireless network that is shared by the office machine. By the network connection sharing method and the network connection sharing system of the present invention, the office machine can be connected to the wireless network that is shared by the mobile device without the need of selecting the SSID of the wireless network and inputting the password through the operation panel of the office machine, and the mobile device can be connected to the wireless network that is shared by the office machine without the need of virtually checking the operation panel. In other words, the network connection sharing method and the network connection sharing system are more user-friendly.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A network connection sharing method for a first electronic device and a second electronic device, the first electronic device being connected to a mobile communication network or a wired communication network, the network connection sharing method comprising steps of:
(A) setting the first electronic device as a hotspot by a first application program module of the first electronic device, so that a wireless network is shared by the first electronic device;
(B) converting a service set identifier and a password of the wireless network into a two-dimensional code image by the first application program module, and outputting the two-dimensional code image from an image output device of the first electronic device; and
(C) reading the two-dimensional code image by an image input device of the second electronic device, wherein after the two-dimensional code image is analyzed by a second application program module of the second electronic device, the service set identifier and the password are acquired, and the second electronic device is connected to the wireless network according to the service set identifier and the password.

2. The network connection sharing method according to claim 1, wherein the two-dimensional code image further contains a password information of the wireless network.

3. The network connection sharing method according to claim 1, wherein the first electronic device is an office machine, and the second electronic device is a mobile device, wherein the image output device is an operation panel or a printing module, and the image input device is a camera lens module.

4. The network connection sharing method according to claim 1, wherein the first electronic device is a mobile device, and the second electronic device is an office machine, wherein the image output device is a display panel, and the image input device is a scanning module.

5. A network connection sharing system for a first electronic device and a second electronic device, the first electronic device being connected to a mobile communication network or a wired communication network, the network connection sharing system comprising:
the first electronic device comprising:
a first application program module, wherein after the first electronic device is set as a hotspot by the first application program module, a wireless network is shared by the first electronic device, wherein a service set identifier and a password of the wireless network are converted into a two-dimensional code image by the first application program module; and
an image output device, wherein the two-dimensional code image is outputted from the image output device; and
the second electronic device comprising:
an image input device reading the two-dimensional code image; and
a second application program module, wherein after the two-dimensional code image is analyzed by the second application program module, the service set identifier and the password are acquired, and the second electronic device is connected to the wireless network according to the service set identifier and the password.

6. The network connection sharing system according to claim 5, wherein the two-dimensional code image further contains a password information of the wireless network.

7. The network connection sharing system according to claim 5, wherein the first electronic device is an office machine, and the second electronic device is a mobile device, wherein the image output device is an operation panel or a printing module, and the image input device is a camera lens module.

8. The network connection sharing system according to claim 5, wherein the first electronic device is a mobile device, and the second electronic device is an office machine, wherein the image output device is a display panel, and the image input device is a scanning module.

9. An office machine with a network connection sharing function, the office machine comprising:
a wireless network module providing the network connection sharing function of the office machine;
a scanning module, wherein after a first two-dimensional code image is read by the scanning module, the first two-dimensional code image is transmitted from the scanning module to an application program module;
the application program module connected to the wireless network module and the scanning module, wherein the application program module converts the first two-dimensional code image into a first service set identifier of a first wireless network so as to connect the office machine to the first wireless network, or the application program module sets the office machine as a hotspot and converts a second service set identifier of a second wireless network shared by the office machine into a second two-dimensional code image;
an operation panel connected to application program module, and displaying the second two-dimensional code image; and
a printing module connected with the application program module, and outputting the second two-dimensional code image on a paper.

10. The office machine according to claim 9, wherein the first two-dimensional code image further contains a first password information of the first wireless network, and the second two-dimensional code image further contains a second password information of the second wireless network.
